(19) United States
(12) Patent Application Publication
(10) Pub. No.: US 2026/0046976 A1
(43) Pub. Date: Feb. 12, 2026

(54) METHOD AND APPARATUS FOR HANDLING NON-ACCESS STRATUM MOBILITY MANAGEMENT CAUSE FOR NON-TERRESTRIAL NETWORK ACCESS

(71) Applicant: MEDIATEK INC., Hsinchu City (TW)

(72) Inventors: Yu-Hsin LIN, Hsinchu City (TW); Marko NIEMI, Oulu (FI); Shao-Liang YEH, Hsinchu City (TW); Kuan-Hua LIN, Hsinchu City (TW); Bo-Hun CHEN, Hsinchu City (TW); Yuan-Chieh LIN, Hsinchu City (TW)

(21) Appl. No.: 19/104,284

(22) PCT Filed: Feb. 4, 2024
(86) PCT No.: PCT/CN2024/075765

§ 371 Date: Feb. 17, 2025

Related U.S. Application Data
(60) Provisional application No. 63/485,559, filed on Feb. 17, 2023.
(60) Provisional application No. 63/485,562, filed on Feb. 17, 2023.

(51) Int. Cl. H04W 76/38; H04W 60/06; H04W 64/00

(52) U.S. Cl. CPC H04W 76/38; H04W 60/06; H04W 64/00

(57) ABSTRACT

Examples pertaining to an apparatus (e.g., a user equipment (UE)) as handling non-access stratum (NAS) mobility management (MM) cause for non-terrestrial network (NTN) access are described. The apparatus receives a first message from a network node of a network. The first message includes the specific cause indicating that a public land mobile network (PLMN) is not allowed to operate at a present location of the apparatus. The apparatus starts a timer. The apparatus releases a connection between the apparatus and the PLMN in an event associated with the timer.

### CROSS REFERENCE TO RELATED PATENT APPLICATION(S)

The present disclosure is part of a non-provisional application claiming the priority benefit of U.S. Patent Application No. 63/485,562, filed 17 Feb. 2023, and U.S. Patent Application No. 63/485,559, filed 17 Feb. 2023. The contents of aforementioned applications are herein incorporated by reference in their entirety.

### TECHNICAL FIELD

The present disclosure is generally related to mobile communications and, more particularly, to handling non-access stratum (NAS) mobility management (MM) cause for non-terrestrial network (NTN) access.

### BACKGROUND

Unless otherwise indicated herein, approaches described in this section are not prior art to the claims listed below and are not admitted as prior art by inclusion in this section.

In conventional network of 3rd Generation Partnership Project (3GPP) (e.g., a fourth generation (4G) Long-Term Evolution (LTE) system or a fifth generation (5G) New Radio (NR) system), NAS is a functional layer between a user equipment (UE) and a core network. For example, in a 5G system (5GS), multiple network functions (NFs) are introduced, such as Access and Mobility Management Function (AMF), Session Management Function (SMF), Short Message Service Function (SMSF), Location Management Function (LMF), and User Plane Function (UPF), and each of the NFs can interact with others by using a reference point/interface. In a 4G system (4GS), the evolved packet core (EPC) includes multiple entities, such as mobile management entity (MME), serving gateway (S-GW), public data network (PDN) gateway (P-GW), home subscriber server (HSS) and policy and charging rules function (PCRF). In addition, a public land mobile network (PLMN) is a network established and operated by an administration or recognized operating agency (ROA) for the specific purpose of providing land mobile communication services to the public in one or a combination of frequency bands. Once a UE is switched on, the UE can perform network and cell selection to select a PLMN that it will register with and to select a cell (and/or a network node) that belongs to the selected PLMN. After confirming the PLMN and the corresponding cell (and/or a network node), the UE can initiate a NAS MM (e.g., evolved packet system (EPS) MM (EMM) or 5G MM (5GMM)) procedure to the core network and interact with the above NFs for wireless communication.

During the NAS MM procedure, the UE may correspondingly receive a message including a specific cause that is used to indicate that the PLMN is not allowed to operate at a present location of the UE, i.e., the UE is restricted from accessing the PLMN via a satellite (cell) at the present location. However, the details of UE operations in handling the specific cause have not been fully discussed yet and some issues need to be solved. For example, upon receiving the specific cause, if the connection between the UE and the PLMN is not released by the network, the UE will keep the connection and not be able to perform a PLMN selection, causing the UE to be stuck in the current PLMN. Another issue relates to the case that when the specific cause is received in certain messages (e.g., a downlink (DL) NAS TRANSPORT message), UE operations regarding how to determine when it can access the same PLMN again are unclear. Moreover, some conditions should be taken into account in regard to allowing UE to access the same PLMN where the specific cause is received. Therefore, there is a need to propose solutions to solve these issues.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is to propose solutions or schemes that address the aforementioned issues pertaining to unclear UE operations in handling the specific cause for NTN access. It is believed that the above-described issues would be avoided or otherwise alleviated by implementing one or more of the proposed schemes described herein.

In one aspect, a method for handling NAS MM cause may involve a processor of an apparatus receiving a first message from a network node of a network. The first message includes a specific cause indicating that a PLMN is not allowed to operate at a present location of the apparatus. In response, the method may involve the processor starting a timer. The method may also involve the processor releasing a connection between the apparatus and the PLMN in an event associated with the timer.

In another aspect, an apparatus for handling NAS MM cause may include a transceiver which, during operation, communicates with a network node of a network. The apparatus may also include a processor communicatively coupled to the transceiver. The processor may receive, via the transceiver, a first message from the network node. The first message includes a specific cause indicating that a PLMN is not allowed to operate at a present location of the apparatus. The processor may start a timer. The processor may release a connection between the apparatus and the PLMN in an event associated with the timer.

In another aspect, a method for handling NAS MM cause may involve a processor of an apparatus registering to a PLMN. The method may also involve the processor receiving a DL NAS TRANSPORT message from a network node. The DL NAS TRANSPORT message includes a specific cause indicating that the PLMN is not allowed to operate at a present location of the apparatus. In response, the method may involve the processor starting a timer. The method may also involve the processor determining not to access the PLMN (e.g., not to transmit any uplink (UL) NAS TRANSPORT message or registration message) via a satellite before the timer expires

It is noteworthy that, although description provided herein may be in the context of certain radio access technologies, networks and network topologies such as 5GS and 4G EPS mobile networking, the proposed concepts, schemes and any variation(s)/derivative(s) thereof may be implemented in, for and by other types of wireless and wired communication technologies, networks and network topologies such as, for example and without limitation, Ethernet, Universal Terrestrial Radio Access Network (UTRAN), E-UTRAN, Global System for Mobile communications (GSM), General Packet Radio Service (GPRS)/Enhanced Data rates for Global Evolution (EDGE) Radio Access Network (GERAN), Long-Term Evolution (LTE), LTE-Advanced, LTE-Advanced Pro, IoT, Industrial IoT (IIoT), Narrow Band Internet of Things (NB-IoT), and any future-developed networking technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network system in accordance with an implementation of the present disclosure.

FIG. 2 illustrates an example communication system having at least an example communication apparatus and an example network apparatus in accordance with an implementation of the present disclosure.

FIG. 3 illustrates an example process in accordance with an implementation of the present disclosure.

FIG. 4 illustrates another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to handling NAS MM cause for NTN access. According to the present disclosure, a number of possible solutions may be implemented separately or jointly. That is, although these possible solutions may be described below separately, two or more of these possible solutions may be implemented in one combination or another.

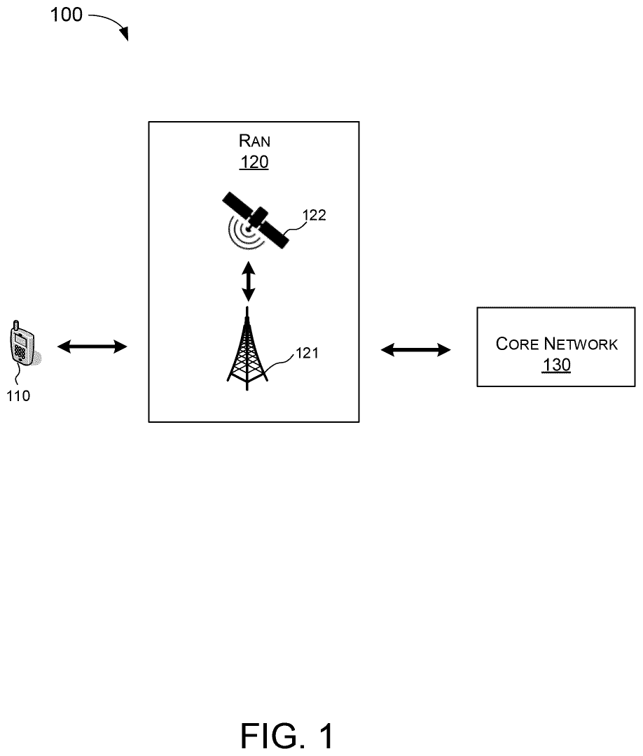

FIG. 1 is a diagram of an example network system 100 in accordance with an implementation of the present disclosure. Generally, the network system 100 may include a UE 110, a radio access network (RAN) 120 and a core network 130. In the UE 110, a protocol stack is introduced with multiple layers, such as a NAS layer that is a configured to communicate with the core network 130 of the network system 100, a radio resource control (RRC) layer that is configured for higher layer configuration and control, a packet data convergence protocol/radio link control (PDCP/RLC) layer, a media access control (MAC) layer and a Physical (PHY) layer.

In one example, if the network system 100 is a 5GS, the core network 130 may include multiple NFs, such as AMF, SMF, SMSF, LMF, UPF and/or other NF. Specifically, the AMF can manage access control and mobility, and support other NFs to communicate with the UE 110 and the RAN 120. The SMF can provide session management, IP address allocation and management, UP function selection and control. The SMSF can manage the SMS subscription and delivery over the NAS layer. The LMF can support location measurement and determination for the UE 110, UL location measurement from the RAN 120. Each of the NFs can interact with others by using a reference point/interface, such as N1, N2, N3, N4, N6 and N11. In another example, if the network system 100 is an EPS, the core network 130 may include multiple entities, such as MME, S-GW, P-GW, HSS and PCRF. Specifically, the MME can provide mobility and session management (including bearer management as well as connection management) to the UE. The S-GW can be responsible for exchanging traffic between the P-GW and the RAN, and the P-GW can be responsible for data traffic between the S-GW and other networks (e.g., IP multimedia subsystem (IMS) or Internet). The HSS can store data for customer profile, create authentication vectors to be sent to the MME and hold information about PDNs to be connected as well as information identifying the MME. The PCRF can provide information of quality of service (QoS) to the P-GW to control charging rules, flow control rules and traffic priority. Each of the above entities can interact with other through different interfaces, such as S1-U, S1-MME, S11, S6a, S5, Gx, Gxc, and SGi.

In addition, the RAN 120 and the core network 130 may be part of a PLMN that is a network established and operated by an administration or ROA for the specific purpose of providing land mobile communication services to the public in one or a combination of frequency bands. Specifically, once the UE 110 is switched on, the UE 110 can perform a network (PLMN) selection to select a PLMN that it will register with and a cell selection to select a cell (and/or a network node) that belongs to the selected PLMN. After confirming the PLMN and the corresponding cell, the UE 110 can initiate a NAS MM procedure to the core network 130 via the RAN 120, which may include at least one base station (BS) 121 (e.g., an evolved NodeB (eNB), a next generation NodeB (gNB), or a transmission and reception point (TRP)) and at least one satellite 122, and then interact with the above NFs/entities for data communication.

Based on non-terrestrial network (NTN) communication, since a satellite (cell) may be configured to serve a few UEs with national and secure concerns, the UE may receive, during a NAS MM procedure, a specific cause that is used to indicate that a PLMN is not allowed to operate at a present location of the UE. In other words, the UE may be restricted from accessing a current PLMN via a satellite (cell) even though only this satellite may be available at the present location of the UE. However, it is noted that, in current 3GPP standards, there are some unresolved issues with respect to UE operations in handling the specific cause for NTN access. For example, upon receiving the specific cause, if the connection between the UE and the PLMN is not released by the network, the UE will keep the connection and not be able to perform a PLMN selection, causing the UE to be stuck in the current PLMN. Another issue relates to the case that when the specific cause is received in certain messages (e.g., a DL NAS TRANSPORT message), UE operations regarding how to determine when it can access the same PLMN again are unclear. Moreover, some conditions (e.g., when there is a need for emergency service, or the UE has moved to a new location) should be taken into account in regard to allowing UE to access the same PLMN where the specific cause is received.

Under a first proposed scheme in accordance with the present disclosure, the UE may receive a first message from a network node (or a core network) of a network (e.g., network system 100), where the first message may include a specific cause indicating that the PLMN is not allowed to operate at a present location of the UE and the network node may be a satellite (cell). Specifically, the first message may include a REGISTRATION REJECT message, a SERVICE REJECT message, a DEREGISTRATION REQUEST message or a DL NAS TRANSPORT message in a condition that the network corresponds to a 5GS. Alternatively, the first message may include an ATTACH REJECT message, a DETACH REQUEST message, a SERVICE REJECT message or a TRACKING AREA UPDATE REJECT message in a condition that the network corresponds to an EPS. The specific cause may include an EMM or 5GMM cause #78 that means “PLMN not allowed to operate at the present UE location”, or another cause value having a similar meaning of not being allowed to operate.

In some implementations, while receiving the first message, the UE may start a guard timer, e.g., timer T3540 or T3440, and enter a deregistered state (e.g., the 5GMM or EMM-DEREGISTERED.PLMN-SEARCH state or the 5GMM or EMM-REGISTERED.PLMN-SEARCH state) for searching other PLMN(s), i.e., the UE can perform the PLMN selection rather than being stuck in the current PLMN. In some implementations, the UE releases a connection between the PLMN and the UE in an event that is associated with the guard timer. Specifically, the event may include that the guard timer expires. In other words, if the guard timer expires after receiving the first message, the UE locally releases its connection with the PLMN (and the core network). In addition, the UE performs a PLMN selection for searching other PLMNs(s) after locally releasing the connection between the PLMN and the UE.

In some implementations, the UE may receive a second message from the network node (or the core network) of the network (e.g., network system 100), where the second message may indicate a release of the connection between the UE and the PLMN. In other words, the network (and/or the PLMN) may determine whether to release the connection with the UE and/or to deny/disregard a request from the UE to register/connect to the core network (and/or the PLMN). If the core network (and/or the PLMN) determines that the PLMN is not allowed to be operate at the present location of the UE, the network may transmit the second message, to the UE, that indicates releasing the connection between the PLMN and the UE. Upon receiving the second message, the UE may stop the guard timer and release the connection with the network (and/or the PLMN). In other words, the network may request the UE to release the connection before the guard timer expires. Accordingly, the UE may be able to perform the PLMN selection after releasing the connection while in a deregistered state.

Thus, by configuring the guard timer (e.g., timer T3540 or T3440) upon receiving the specific cause indicating that the PLMN is not allowed to operate at the present location of the UE, the UE may be able to release the connection with the current PLMN (and/or the core network) while in a deregistered state for searching other PLMN(s).

Under a second proposed scheme in accordance with the present disclosure, the UE may first register to the PLMN (and/or the core network) and select a network node, e.g., a satellite, corresponding to the PLMN. Then, if it is determined that the PLMN is not allowed to operate at a present location of the UE, the UE may receive a DL NAS TRANSPORT message including a specific cause from the network node, where the specific cause may indicate that the PLMN is not allowed to operate at the present location of the UE. Specifically, the specific cause may include an EMM or 5GMM cause #78, which means “PLMN not allowed to operate at the present UE location”.

In some implementations, upon receiving the DL NAS TRANSPORT message from the satellite, the UE may start a prohibit timer. Then, in some implementations, the UE determines not to access the PLMN (e.g., not to transmit any UL NAS TRANSPORT message or registration message) via a satellite before the prohibit timer expires.

In some implementations, upon starting the prohibit timer, the UE may store an identity (ID) of the PLMN to a list, where the list may indicate a list of “PLMNs not allowed to operate at the present UE location”.

In some implementations, upon starting the prohibit timer, the UE locally enters a deregistered state to perform a PLMN selection. Specifically, the UE enters/switches into the 5GMM or EMM-DEREGISTERED.PLMN-SEARCH state or the 5GMM or EMM-REGISTERED.PLMN-SEARCH state for searching other PLMN(s). Alternatively, in some implementations, upon starting the prohibit timer, the core network (and/or the PLMN) may transmit an indication to the UE, to have the UE enter/switch into the 5GMM or EMM-DEREGISTERED.PLMN-SEARCH state or the 5GMM or EMM-REGISTERED.PLMN-SEARCH state for searching other PLMN(s).

In some implementations, upon receiving the DL NAS TRANSPORT message from the network node, there may be some exceptional scenarios/conditions for the UE to access the same PLMN again even though the core network (and/or the PLMN) initially determines that the UE should not be allowed to operate at the present location via a satellite (cell). The exceptional scenarios/conditions may be that a distance between a geographical location where the DL NAS TRANSPORT message was received and a current location of the UE is larger than a specific value (e.g., a UE implementation specific value). Alternatively, the exceptional scenarios/conditions may be that the prohibit timer expires or the access is for is an emergency service. Once the exceptional scenarios/condition(s) is/are met (e.g., it is emergent for the UE to request an access at the present location or the UE has moved to a new location), the UE may transmit at least one indication to the PLMN (and/or the core network) for requesting the emergency service. After receiving the indication indicating the emergency service, the core network (and/or the PLMN) may allow the UE to operate at the present location by configuring available resource(s) for the current satellite.

Therefore, based on the above mechanisms/solutions with adaptively configuring at least one timer (e.g., guard timer and/or prohibit timer) upon receiving a specific cause indicating that the PLMN is not allowed to operate at the present location of the UE, the connection between the PLMN and the UE may be timely released (which may be triggered by the UE or indicated from the core network/PLMN), and/or the UE may explicitly determine for how long it is restricted from accessing the same PLMN (i.e., to determine when it can access the same PLMN again), which may solve the dilemma that the UE fails to disconnect/reconnect with the current PLMN after receiving the specific cause. In addition, if the UE requests an emergency service upon receiving the same specific cause, some exceptional scenarios/conditions are proposed for the UE to re-access the current PLMN through a satellite corresponding to the current PLMN, which may increase more flexibility for the UE and/or the PLMN.

### Illustrative Implementations

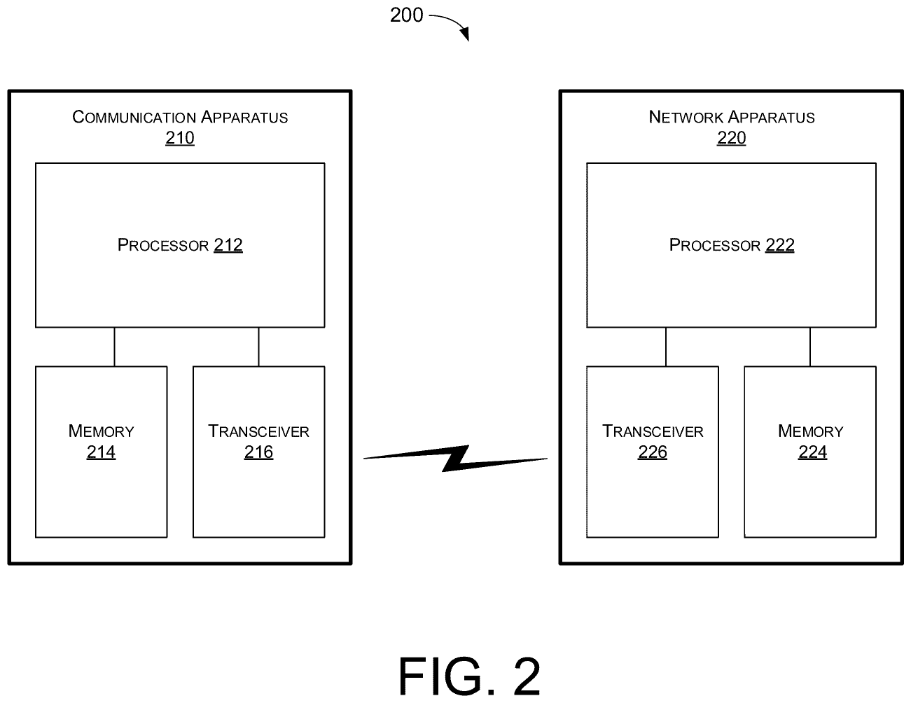

FIG. 2 illustrates an example communication system 200 having at least an example communication apparatus 210 and an example network apparatus 220 in accordance with an implementation of the present disclosure. Each of apparatus 210 and apparatus 220 may perform various functions to implement schemes, techniques, processes and methods described herein pertaining to handling NAS MM cause for NTN access, including the various schemes described above with respect to various proposed designs, concepts, schemes, systems and methods described above, including network system 100, as well as processes described below.

Each of apparatus 210 and apparatus 220 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 210 and apparatus 220 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 210 and apparatus 220 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 210 and apparatus 220 may be implemented in a smart thermostat, a smart fridge, a smart door lock, a wireless speaker or a home control center. When implemented in or as a network apparatus, apparatus 210 and/or apparatus 220 may be implemented in an eNB in an LTE, LTE-Advanced or LTE-Advanced Pro network or in a gNB, a satellite, a repeater or TRP in a 5G network, an NR network or an IoT network.

In some implementations, each of apparatus 210 and apparatus 220 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 210 and apparatus 220 may be implemented in or as a network apparatus or a UE. Each of apparatus 210 and apparatus 220 may include at least some of those components shown in FIG. 2 such as a processor 212 and a processor 222, respectively, for example. Each of apparatus 210 and apparatus 220 may further include one or more other components not pertinent to the proposed scheme of the present disclosure (e.g., internal power supply, display device and/or user interface device), and, thus, such component(s) of apparatus 210 and apparatus 220 are neither shown in FIG. 2 nor described below in the interest of simplicity and brevity.

In one aspect, each of processor 212 and processor 222 may be implemented in the form of one or more single-core processors, one or more multi-core processors, or one or more CISC or RISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged and configured to perform specific tasks including those pertaining to handling NAS MM cause for NTN access in accordance with various implementations of the present disclosure.

In some implementations, apparatus 210 may also include a transceiver 216 coupled to processor 212. Transceiver 216 may be capable of wirelessly transmitting and receiving data. In some implementations, transceiver 216 may be capable of wirelessly communicating with different types of networks of different radio access technologies (RATs). In some implementations, transceiver 216 may be equipped with a plurality of antenna ports (not shown) such as, for example, four antenna ports. That is, transceiver 216 may be equipped with multiple transmit antennas and multiple receive antennas for multiple-input multiple-output (MIMO) wireless communications. In some implementations, apparatus 220 may also include a transceiver 226 coupled to processor 222. Transceiver 226 may include a transceiver capable of wirelessly transmitting and receiving data. In some implementations, transceiver 226 may be capable of wirelessly communicating with different types of UEs/networks of different RATs. In some implementations, transceiver 226 may be equipped with a plurality of antenna ports (not shown) such as, for example, four antenna ports. That is, transceiver 226 may be equipped with multiple transmit antennas and multiple receive antennas for MIMO wireless communications.

In some implementations, apparatus 210 may further include a memory 214 coupled to processor 212 and capable of being accessed by processor 212 and storing data therein. In some implementations, apparatus 220 may further include a memory 224 coupled to processor 222 and capable of being accessed by processor 222 and storing data therein. Each of memory 214 and memory 224 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 214 and memory 224 may include a type of read-only memory (ROM) such as mask ROM, programmable ROM (PROM), erasable programmable ROM (EPROM) and/or electrically erasable programmable ROM (EEPROM). Alternatively, or additionally, each of memory 214 and memory 224 may include a type of non-volatile random-access memory (NVRAM) such as flash memory, solid-state memory, ferroelectric RAM (FeRAM), magnetoresistive RAM (MRAM) and/or phase-change memory. Alternatively, or additionally, each of memory 214 and memory 224 may include a UICC.

Each of apparatus 210 and apparatus 220 may be a communication entity capable of communicating with each other using various proposed schemes in accordance with the present disclosure. For illustrative purposes and without limitation, a description of capabilities of apparatus 210, as a UE (e.g., UE 110) and/or a network node (e.g., BS 121 and/or satellite 122) of a network, is provided below.

Under certain proposed schemes in accordance with the present disclosure with respect to the UE's perspective of handling NAS MM cause for NTN access, processor 212 of apparatus 210, implemented in or as UE 110, may receive, via transceiver 216, a first message from a network node of a network, where the first message may include a specific cause indicating that a PLMN is not allowed to operate at a present location of the apparatus (e.g., UE 110). Additionally, processor 212 may start a timer (or called a guard timer). Additionally, processor 212 may release a connection between the apparatus and the PLMN in an event associated with the timer.

In some implementations, the event may include that the timer expires.

In some implementations, processor 212 may stop the timer responsive to receiving a second message, where the second message may indicate release of the connection between the apparatus (e.g., UE 110) and the PLMN.

In some implementations, the first message may include at least one of a REGISTRATION REJECT message, a SERVICE REJECT message, a DEREGISTRATION REQUEST message and a DL NAS TRANSPORT message in a condition that the network corresponds to a 5GS.

In some implementations, the first message may include at least one of an ATTACH REJECT message, a DETACH REQUEST message, a SERVICE REJECT message and a TRACKING AREA UPDATE REJECT message in a condition that the network corresponds to an EPS.

In some implementations, the specific cause may include an EMM or 5GMM cause #78, and the network node may include a satellite.

In some implementations, the timer may include a timer T3540 or a timer T3440.

In some implementations, processor 212 may perform a PLMN selection responsive to releasing the connection between the apparatus (e.g., UE 110) and the PLMN.

Under certain proposed schemes in accordance with the present disclosure with respect to the UE's perspective of handling NAS MM cause for NTN access, processor 212 of apparatus 210, implemented in or as UE 110, may register to a PLMN. Additionally, processor 212 may receive, via transceiver 216, a DL NAS TRANSPORT message from a network node, where the DL NAS TRANSPORT message may include a specific cause indicating that the PLMN is not allowed to operate at a present location of the apparatus (e.g., UE 110). Additionally, processor 212 may start a timer (or called a prohibit timer). Additionally, processor 212 may determine not to access the PLMN (e.g., not to transmit any UL NAS TRANSPORT message or registration message) via a satellite before the timer expires.

In some implementations, processor 212 may store an ID of the PLMN. Additionally, the processor 212 may enter a deregistered state to perform a PLMN selection.

In some implementations, processor 212 may determine that the apparatus (e.g., UE 110) is allowed to access the PLMN in a condition that a distance between a geographical location where the DL NAS TRANSPORT message was received and a current location of the apparatus (e.g., UE 110) is larger than a specific value; or the timer expires; or an access is for an emergency service.

In some implementations, the specific cause may include an EMM or 5GMM cause #78, and the network node may include a satellite.

Under certain proposed schemes in accordance with the present disclosure with respect to the NW's perspective of handling NAS MM cause for NTN access, processor 222 of apparatus 220, implemented in or as a network node (e.g., BS 121 and/or satellite 122) of a network, may transmit, via transceiver 226, a first message to the UE (e.g., UE 110), where the first message may include a specific cause indicating that a PLMN is not allowed to operate at a present location of the apparatus (e.g., UE 110). Additionally, the processor 222 may release a connection between the apparatus (e.g., UE 110) and the PLMN in an event associated with a timer (or called a guard timer) of the apparatus (e.g., UE), where the event may include the timer expires. The timer may include a timer T3540, timer T3440 or another type of timer.

In some implementations, processor 222 may transmit, via transceiver 226, a second message to the apparatus (e.g., UE 110), where the second message may indicate release of the connection between the apparatus (e.g., UE 110) and the PLMN.

In some implementations, the first message may include at least one of a REGISTRATION REJECT message, a SERVICE REJECT message, a DEREGISTRATION REQUEST message and a DL NAS TRANSPORT message in a condition that the network corresponds to a 5GS.

In some implementations, the first message may include at least one of an ATTACH REJECT message, a DETACH REQUEST message, a SERVICE REJECT message and a TRACKING AREA UPDATE REJECT message in an event that the network corresponds to an EPS.

In some implementations, the specific cause may include an EMM or 5GMM #78, and the network node may include a satellite.

Under certain proposed schemes in accordance with the present disclosure with respect to the NW's perspective of handling NAS MM cause for NTN access, processor 222 of apparatus 220, implemented in or as a network node (e.g., BS 121 and/or satellite 122) of the RAN 120, may receive, via a transceiver 226, a registration from an apparatus (e.g., UE 110) to a PLMN. Additionally, processor 222 may transmit, via transceiver 226, a DL NAS TRANSPORT message to the UE (e.g., UE 110), where the DL NAS TRANSPORT message may include a specific cause indicating that a PLMN is not allowed to operate at a present location of the apparatus (e.g., UE 110). Additionally, the processor 222 may not receive, via transceiver 226, any access attempt (e.g., UL NAS TRANSPORT message or registration message) from the apparatus (e.g., UE 110) accessing via a satellite before a timer (or called a prohibit timer) of the apparatus (e.g., UE 110) expires.

In some implementations, processor 222 may determine that the apparatus (e.g., UE 110) is allowed to access the PLMN in a condition that a distance between a geographical location where the DL NAS TRANSPORT message was received and a current location of the apparatus (e.g., UE 110) is larger than a specific value; or the timer expires; or an access is for an emergency service.

In some implementations, the specific cause may include an EMM or 5GMM cause #78, and the network node may include a satellite.

### Illustrative Processes

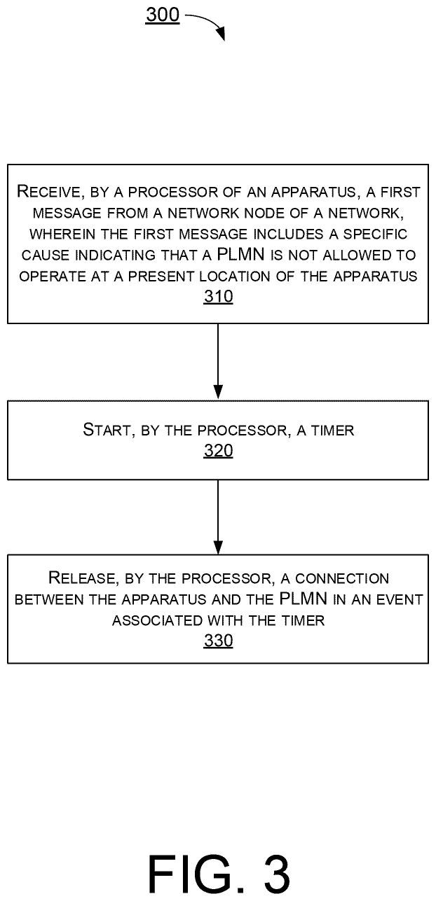

FIG. 3 illustrates an example process 300 in accordance with an implementation of the present disclosure. Process 300 may represent an aspect of implementing various proposed designs, concepts, schemes, systems and methods described above, whether partially or entirely, including those described above. More specifically, process 300 may represent an aspect of the proposed concepts and schemes pertaining to handling NAS MM cause for NTN access. Process 300 may include one or more operations, actions, or functions as illustrated by one or more of blocks 310 to 330. Although illustrated as discrete blocks, various blocks of process 300 may be divided into additional blocks, combined into fewer blocks, or eliminated, depending on the desired implementation. Moreover, the blocks/sub-blocks of process 300 may be executed in the order shown in FIG. 3 or, alternatively in a different order. Furthermore, one or more of the blocks/sub-blocks of process 300 may be executed iteratively. Process 300 may be implemented by or in apparatus 210 and apparatus 220 as well as any variations thereof. Solely for illustrative purposes and without limiting the scope, process 300 is described below in the context of apparatus 210 as a UE (e.g., UE 110) and apparatus 220 as a communication entity such as a network node (e.g., BS 121 and/or satellite 122) of a network. Process 300 may begin at block 310.

At 310, process 300 may involve processor 212 of apparatus 210, implemented in or as UE 110, receiving, a first message from a network node of a network, where the first message may include a specific cause indicating that a PLMN is not allowed to operate at a present location of the apparatus (e.g., UE 110). Process 300 may proceed from 310 to 320.

At 320, process 300 may involve processor 212 starting a (guard) timer. Process 300 may proceed from 320 to 330.

At 330, process 300 may involve processor 212 releasing a connection between the apparatus (e.g., UE 110) and the PLMN in an event associated with the timer.

In some implementations, the event may include that the timer expires.

In some implementations, process 300 may further involve processor 212 stopping the timer responsive to receiving a second message, where the second message may indicate release of the connection between the apparatus (e.g., UE 110) and the PLMN.

In some implementations, the first message may include at least one of a REGISTRATION REJECT message, a SERVICE REJECT message, a DEREGISTRATION REQUEST message and a DL NAS TRANSPORT message in a condition that the network corresponds to a 5GS.

In some implementations, the first message may include at least one of an ATTACH REJECT message, a DETACH REQUEST message, a SERVICE REJECT message and a TRACKING AREA UPDATE REJECT message in an event that the network corresponds to an EPS.

In some implementations, the specific cause may include an EMM or 5GMM cause #78, and the network node may include a satellite.

In some implementations, the timer may include a timer T3540 or a timer T3440.

In some implementations, process 300 may further involve processor 212 performing a PLMN selection responsive to releasing the connection between the apparatus (e.g., UE 110) and the PLMN.

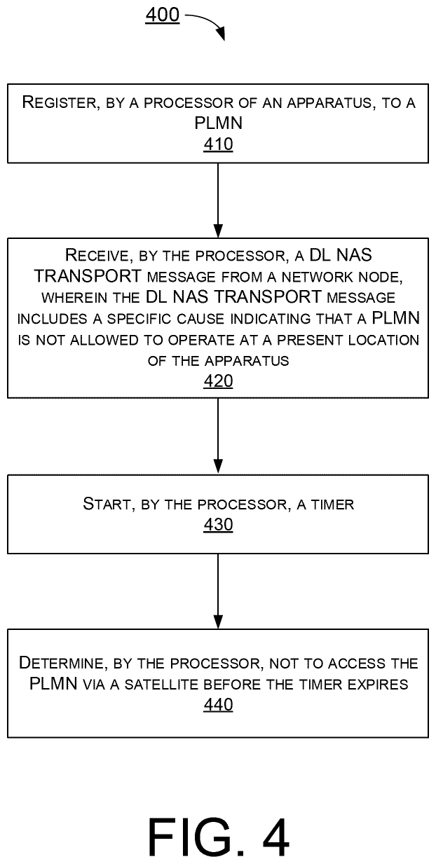

FIG. 4 illustrates another example process 400 in accordance with an implementation of the present disclosure. Process 400 may represent an aspect of implementing various proposed designs, concepts, schemes, systems and methods described above, whether partially or entirely, including those described above. More specifically, process 400 may represent an aspect of the proposed concepts and schemes pertaining to handling NAS MM cause for NTN access. Process 400 may include one or more operations, actions, or functions as illustrated by block 410 to 440. Although illustrated as discrete blocks, various block of process 400 may be divided into additional blocks, combined into fewer blocks, or eliminated, depending on the desired implementation. Moreover, the blocks/sub-blocks of process 400 may be executed in the order shown in FIG. 4 or, alternatively in a different order. Furthermore, one or more of the blocks/sub-blocks of process 400 may be executed iteratively. Process 400 may be implemented by or in apparatus 210 and apparatus 220 as well as any variations thereof. Solely for illustrative purposes and without limiting the scope, process 400 is described below in the context of apparatus 210 as a UE (e.g., UE 110) and apparatus 220 as a communication entity such as a network node (e.g., BS 121 and/or satellite 122) of a network. Process 400 may begin at block 410.

At 410, process 400 may involve processor 212 of apparatus 210, implemented in or as a UE (e.g., UE 110), registering to a PLMN. Process 400 may proceed from 410 to 420.

At 420, process 400 may involve processor 212 receiving a DL NAS TRANSPORT message from a network node, where the DL NAS TRANSPORT message may include a specific cause indicating that a PLMN is not allowed to operate at a present location of the apparatus (e.g., UE 110). Process 400 may proceed from 420 to 430.

At 430, process 400 may involve processor 212 starting a (prohibit) timer. Process 400 may proceed from 430 to 440.

At 440, process 400 may involve processor 212 determining not to access the PLMN (e.g., not to transmit any UL NAS TRANSPORT message or registration message) via a satellite before the timer expires.

In some implementations, process 400 may involve processor 212 storing an ID of the PLMN and entering a deregistered state to perform a PLMN selection.

In some implementations, process 400 may involve processor 212 determining that the apparatus (e.g., UE 110) is allowed to access the PLMN in a condition that a distance between a geographical location where the DL NAS TRANSPORT message was received and a current location of the apparatus (e.g., UE 110) is larger than a specific value; or the timer expires; or an access is for an emergency service.

In some implementations, the specific cause may include an EMM or 5GMM cause #78, and the network node may include a satellite.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method for handling non-access stratum (NAS) mobility management (MM) cause, comprising:
receiving, by a processor of an apparatus, a first message from a network node of a network, wherein the first message comprises a specific cause indicating that a public land mobile network (PLMN) is not allowed to operate at a present location of the apparatus;
starting, by the processor, a timer; and
releasing, by the processor, a connection between the apparatus and the PLMN in an event associated with the timer.

2. The method of claim 1, wherein the event comprises that the timer expires.

3. The method of claim 1, wherein the event comprises:
stopping, by the processor, the timer responsive to receiving a second message, wherein the second message indicates release of the connection between the apparatus and the PLMN.

4. The method of claim 1, wherein the first message comprises at least one of a REGISTRATION REJECT message, a SERVICE REJECT message, a DEREGISTRATION REQUEST message and a downlink (DL) NAS TRANSPORT message in a condition that the network corresponds to a fifth generation system (5GS).

5. The method of claim 1, wherein the first message comprises at least one of an ATTACH REJECT message, a DETACH REQUEST message, a SERVICE REJECT message and a TRACKING AREA UPDATE REJECT message in an event that the network corresponds to an evolved packet system (EPS).

6. The method of claim 1, wherein the specific cause comprises an EPS mobility management or 5G NAS mobility management (EMM or 5GMM) cause #78, and wherein the network node comprises a satellite.

7. The method of claim 1, wherein the timer comprises a timer T3540 or a timer T3440.

8. The method of claim 1, further comprising:
preforming, by the processor, a PLMN selection responsive to releasing the connection between the apparatus and the PLMN.

9. An apparatus for handling non-access stratum (NAS) mobility management (MM) cause, comprising:
a transceiver which, during operation, communicates with a network node of a network; and
a processor communicatively coupled to the transceiver, wherein the processor receives, via the transceiver, a first message from the network node, the first message comprises a specific cause indicating that a public land mobile network (PLMN) is not allowed to operate at a present location of the apparatus, starts a timer, and releases a connection between the apparatus and the PLMN in an event associated with the timer.

10. The apparatus of claim 9, wherein the event comprises that the timer expires.

11. The apparatus of claim 9, wherein the processor further stops the timer responsive to receiving a second message, wherein the second message indicates release of the connection between the apparatus and the PLMN.

12. The apparatus of claim 9, wherein the first message comprises at least one of a REGISTRATION REJECT message, a SERVICE REJECT message, a DEREGISTRATION REQUEST message and a downlink (DL) NAS TRANSPORT message in a condition that the network corresponds to a fifth generation system (5GS).

13. The apparatus of claim 9, wherein the first message comprises at least one of an ATTACH REJECT message, a DETACH REQUEST message, a SERVICE REJECT message and a TRACKING AREA UPDATE REJECT message in a condition that the network corresponds to an evolved packet system (EPS).

14. The apparatus of claim 9, wherein the specific cause comprises an EPS mobility management or 5G NAS mobility management (EMM or 5GMM) cause #78, and wherein the network node comprises a satellite.

15. The apparatus of claim 9, wherein the timer comprises a timer T3540 or a timer T3440.

16. The apparatus of claim 9, wherein the processor further performs a PLMN selection responsive to releasing the connection between the apparatus and the PLMN.

17. A method for handling non-access stratum (NAS) mobility management (MM) cause, comprising:
registering, by a processor of an apparatus, to a public land mobile network (PLMN);
receiving, by the processor, a downlink (DL) non-access stratum (NAS) TRANSPORT message from a network node, wherein the DL NAS TRANSPORT message comprises a specific cause indicating that the PLMN is not allowed to operate at a present location of the apparatus;
starting, by the processor, a timer; and
determining, by the processor, not to access the PLMN via a satellite before the timer expires.

18. The method of claim 17, further comprising:
storing, by the processor, an identity (ID) of the PLMN; and
entering, by the processor, a deregistered state to perform a PLMN selection.

19. The method of claim 17, further comprising:
determining, by the processor, that the apparatus is allowed to access the PLMN in a condition that:
a distance between a geographical location where the DL NAS TRANSPORT message was received, and a current location of the apparatus is larger than a specific value; or
the timer expires; or
an access is for an emergency service.

20. The method of claim 17, wherein the specific cause comprises an evolved packet system (EPS) mobility management or 5G NAS mobility management (EMM or 5GMM) cause #78, and wherein the network node comprises a satellite.
